(19) United States
(12) Patent Application Publication
(10) Pub. No.: US 2011/0030882 A1
(43) Pub. Date: Feb. 10, 2011

(54) ADHESIVE SHEET FOR SUPPORTING AND PROTECTING SEMICONDUCTOR WAFER AND METHOD FOR GRINDING BACK OF SEMICONDUCTOR WAFER

(75) Inventors: Kouji MIZUNO, Ibaraki-shi (JP); Fumiteru ASAI, Ibaraki-shi (JP); Takatoshi SASAKI, Ibaraki-shi (JP)

Correspondence Address: SUGHRUE MION, PLLC, 2100 PENNSYLVANIA AVENUE, N.W., SUITE 800, WASHINGTON, DC, 20037, US

(73) Assignee: NITTO DENKO CORPORATION, Osaka (JP)

(21) Appl. No.: 12/852,135

(22) Filed: Aug. 6, 2010

(30) Foreign Application Priority Data
Aug. 7, 2009 (JP) 2009-184083

(51) Int. Cl. B32B 38/10; B32B 27/30; B32B 7/02; C09J 7/02

(52) U.S. Cl. 156/153; 428/214

(57) ABSTRACT

An adhesive sheet for supporting and protecting a semiconductor wafer has an intermediate layer and an adhesive layer formed on a one side of a base film in this order, the adhesive layer being made of a radiation curing type adhesive, and having a thickness of 1 to 50 μm and a shear stress of 0.5 to 10 MPa, the intermediate layer having a thickness of 10 to 500 μm and an elastic modulus of 0.01 to 3 MPa. The adhesive sheet of the present invention is useful in the broader application such as an adhesive sheet for affixing a wafer and for protecting a wafer, and the like in various steps of working the semiconductor wafers, that needs re-peelable.

### BACKGROUND

1. Technical Field

The present invention relates to an adhesive sheet for supporting and protecting a semiconductor wafer, and to a method for grinding the back of a semiconductor wafer, and more particularly relates to an adhesive sheet for supporting and protecting a semiconductor wafer and to a method for grinding the back of a semiconductor wafer, which can be used to advantage with semiconductor wafers having protruding bumps on their surface.

2. Related Art

Damage to the pattern surface, fouling by grinding debris, grinding water, and the like can occur in a back grinding step in which the back of a semiconductor wafer is subjected to polishing and grinding, and in a dicing step in which the wafer is cut into individual chips.

Also, the semiconductor wafer itself is thin and brittle, and in addition there are electrodes and other such protrusions on the pattern surface of the semiconductor wafer, so a problem is that even a slight external force tends to cause damage.

A method in which a back grinding tape or other such adhesive sheet is affixed to the pattern surface of a semiconductor wafer is known as a way to prevent damage, fouling, and the like to a semiconductor wafer and to protect the face on which the circuit pattern is formed, during the working of a semiconductor wafer (for example JP-2005-303068-A).

A back grinding tape usually conforms (or follows) to the surface irregularities (or protrusions, bumps, etc.) on the face of the semiconductor wafer where the circuit pattern is formed, and fills in the spaces between protrusions with an adhesive layer, which prevents grinding water or foreign objects from penetrating to the pattern formation face, and prevents cracking in the wafer during or after grinding.

However, as semiconductor devices have become smaller and their density has risen in recent years, the height of the protrusions on the circuit pattern surface of these semiconductor wafers has been on the rise, and the pitch between the protrusions has been decreasing. For example, with a wafer equipped with a polyimide film, the height difference is about 1 to 20 μm. Also, defect marks (bad marks) for recognizing defective semiconductor chips have bumps with a height difference of about 10 to 70 μm. Further, with bumps formed in the form of patterned electrodes, the height is about 20 to 200 μm, the diameter is about 100 μm, the pitch is about 200 μm or less.

Accordingly, with a conventional method employing an adhesive sheet, the sheet could not adequately conform to these bumps, and adhesion was therefore unsatisfactory between the adhesive and the wafer surface. As a result, during wafer working, problems such as sheet separation, penetration of grinding water, foreign objects, and the like to the pattern surface, improper working, dimpling, chip skipping, and the like were encountered, and damage to the wafer also occurred.

Also, when the adhesive sheet was peeled from the semiconductor wafer, the adhesive that filled the spaces between protrusions would sometimes break and leave a sticky residue on the semiconductor wafer side. This problem of sticky residue was particularly pronounced when using a relatively flexible adhesive in order to make the adhesive sheet conform to the irregularities better.

### SUMMARY

The present invention was conceived in light of the above problems, and it is an object thereof to provide an adhesive sheet for supporting and protecting a semiconductor wafer, and to a method for grinding the back of a semiconductor wafer, in which sticky residue attributable to the irregularities on the pattern formation surface of today's semiconductor wafers can be effectively prevented.

As semiconductor devices have become smaller in size with increased density in recent years, the inventors earnestly conducted research on issues such as an increase in the height of the protrusions on the pattern formation surface of semiconductor wafers, a wide variety of property of the adhesive sheet affixed to such surface protrusions, a state in which the adhesive sheet is affixed to such surface protrusions. As a result, the present invention was completed upon finding that a sticky residue from the adhesive layer on the protrusions of the semiconductor wafer having increasingly smaller protrusion pitch and widening difference in height between the protrusions can be reduced dramatically by balancing the intermediate layer and the adhesive layer to have a certain and appropriate degree of thickness, elastic modulus and/or shear stress, as well as by reducing appropriately a contact area between the adhesive layer and the surface protrusions so that the adhesive sheet is controlled to conform closely to the protrusions instead of conforming strictly to the protrusions.

The present invention provides an adhesive sheet for supporting and protecting a semiconductor wafer comprising an intermediate layer and an adhesive layer formed on a one side of a base film in this order,

the adhesive layer being made of a radiation curing type adhesive, and having a thickness of 1 to 50 μm and a shear stress of 0.5 to 10 MPa,

the intermediate layer having a thickness of 10 to 500 μm and an elastic modulus of 0.01 to 3 MPa.

Further, the present invention provides a method for grinding the back of a semiconductor wafer comprising a step of grinding the back of the semiconductor wafer at a state in which an adhesive sheet for supporting and protecting the semiconductor wafer according to the above is affixed to the semiconductor wafer surface having a circuit pattern,

the circuit pattern having irregularities with 15 μm or more of height from the surface of the semiconductor surface.

With the adhesive sheet of the present invention, the problem of sticky residue attributable to the irregularities on the pattern formation surface of today's semiconductor wafers can be effectively prevented.

Using this adhesive sheet affords a dramatic reduction in sticky residue when the adhesive sheet is peeled away after it is used, and also raises the yield of the product.

### BRIEF DESCRIPTION OF DRAWINGS

FIG. 1 is a schematic cross sectional view showing an adhesive sheet for supporting and protecting a semiconductor wafer according to the present invention.

FIGS. 2a and 2b are schematic cross sectional views showing a bonded an adhesive sheet of the present invention to the semiconductor wafer.

### DETAILED DESCRIPTION OF EXEMPLARY EMBODIMENTS

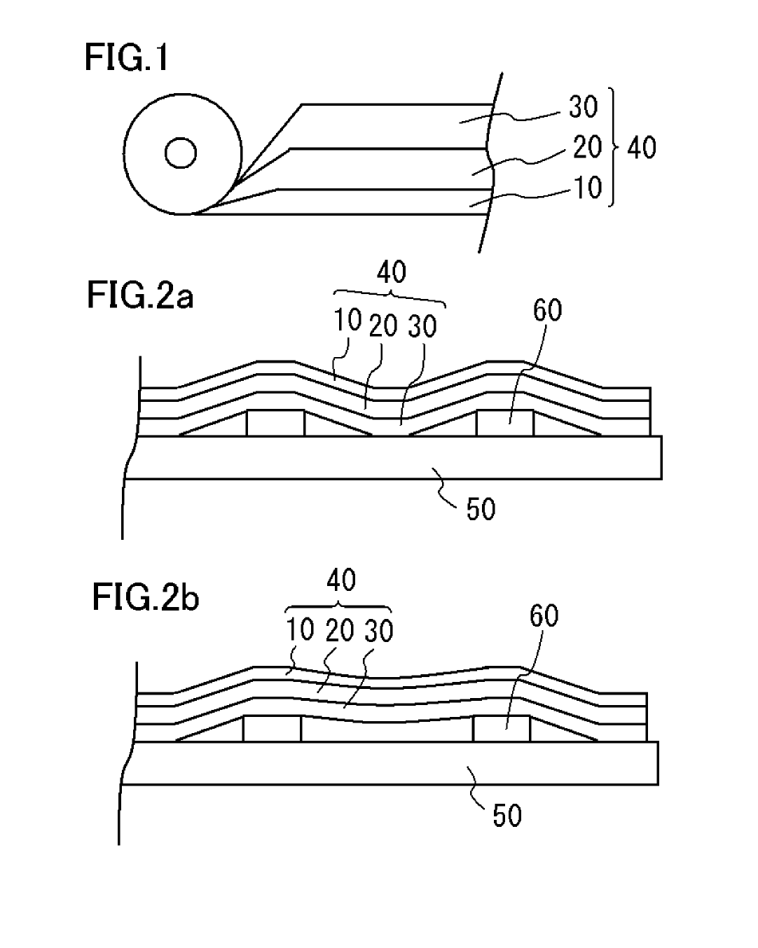

An adhesive sheet for supporting and protecting a semiconductor wafer (hereinafter referred to as “the adhesive sheet”) of the invention mainly comprises a base film 10, an intermediate layer 20 and an adhesive layer 30 which are laminated in this order, as shown in FIG. 1.

The adhesive sheet of the present invention is mainly used to support a semiconductor wafer or to protect its surface by being affixed to the circuit pattern formation surface of the semiconductor wafer in the manufacture of a semiconductor device using an element semiconductor (Si, Ge, etc.) or compound semiconductor (GaAs, etc.) wafer. The adhesive sheet of the present invention for supporting and protecting a semiconductor wafer is particularly useful when irregularities attributable to circuit patterns, bumps, and the like are formed on the surface of a semiconductor wafer. The adhesive sheet can be used for grinding the back of the semiconductor wafer, dicing the semiconductor wafer, and other such processing the semiconductor wafer.

Because the semiconductor wafer supporting and protecting adhesive sheet of the present invention is thus constituted by a base film, an intermediate layer, and an adhesive layer, a good balance is struck between the intermediate layer thickness and its intrinsic properties, and the adhesive layer thickness and its intrinsic properties, so the adhesive sheet fills in the spaces between protrusions on a semiconductor wafer on which irregularities are formed; in other words, the conformity to a semiconductor wafer surface having irregularities can be suitably controlled, and sticky residue on the semiconductor wafer around the irregularities can be effectively prevented even after the sheet is peeled off.

The adhesive layer of the adhesive sheet of the present invention is formed from an adhesive, and there are no particular restrictions on this adhesive so long as it has the proper adhesive strength, hardness, and other such properties, and any adhesive known in this field can be used. Examples include acrylic-based adhesives, silicone-based adhesives, and rubber-based adhesives. A single type of adhesive may be used, or two or more types may be mixed. An acrylic adhesive is particularly preferable in terms of ease of adjusting the adhesive strength and ease of molecular design.

Examples of an acrylic-based polymer which is a base polymer of the acrylic-based adhesive include a polymer derived from at least one monomer component of (meth)acrylic alkyl (with 30 or fewer carbons) ester, which preferably has linear or branched alkyl groups with 4 to 18 carbons, such as methyl, ethyl, n-propyl, isopropyl, n-butyl, t-butyl, isobutyl, pentyl, isopentyl, hexyl, cyclohexyl, heptyl, 2-ethylhexyl, octyl, isooctyl, nonyl, isononyl, decyl, isodecyl, undecyl, rauryl, tridecyl, tetradecyl, stearyl, octadecyl, and dodecyl.

In this specification, the (meth)acrylate means at least one of acrylate or methacrylate.

The acrylic polymer may be added a monomer that can be copolymerized with other monomers (hereinafter referred to as “copolymerizable monomer”) for purpose of modifiying an adhesive property by introducing a functional group, a polar group and the like, for improving or modifying a cohesion or thermostability by controlling a glass transition temperature of the copolymer.

Examples of such copolymerizable monomer include;

a carboxyl-containing monomer such as (meth)acrylic acid, carboxyethyl (meth)acrylate, carboxypentyl (meth)acrylate, itaconic acid, maleic acid, fumaric acid and crotonic acid;

an acid anhydride-containing monomer such as maleic anhydride and itaconic anhydride;

a hydroxyl group-containing monomer such as 2-hydroxyethyl (meth)acrylate, 2-hydroxypropyl (meth)acrylate, 4-hydroxybutyl (meth)acrylate, 6-hydroxyhexyl (meth)acrylate, 8-hydroxyoctyl (meth)acrylate, 10-hydroxydodecyl (meth)acrylate, 12-hydroxyrauryl (meth)acrylate, (4-hydroxymethyl cyclohexyl)methyl(meth)acrylate;

a sulfonate-containing monomer such as styrenesulfonate, allylsulfonate, 2-(meth)acrylamide-2-methyl propanesulfonate, (meth) acrylamide propanesulfonate, sulfopropyl (meth)acrylate, (meth)acryloyloxy naphthalenesulfonate;

a phosphate-containing monomer such as 2-hydroxyethyl acryloylphosphate.

The (meth)acrylic acid alkyl ester that is the main component and the copolymerizable monomer are preferably adjusted so that the former accounts for 70 to 100 wt %, and more preferably 85 wt to 95 wt %, and the latter accounts for 0 to 30 wt %, and more preferably 5 to 15 wt %. A good balance between adhesion, cohesive strength, and the like can be obtained by using the components in amounts within these ranges.

The acrylic polymer may also include a multifunctional monomer or the like as needed, for the purpose of cross-linking and the like.

Examples of the multifunctional monomer include hexanediol di(meth)acrylate, (poly)ethyleneglycol di(meth)acrylate, (poly)propyleneglycol di(meth)acrylate, neopentylglycol di(meth)acrylate, pentaerythritol di(meth)acrylate, trimethylolpropane tri(meth)acrylate, pentaerythritol tri(meth)acrylate, dipentaerythritol hexa(meth)acrylate, epoxy(meth)acrylate, polyester (meth)acrylate and urethane (meth)acrylate.

These multifunctional monomers can be used alone or as mixture of two or more monomers.

In terms of adhesion characteristics and the like, the amount in which the multifunctional monomer is used is preferably about 30 mol % or less of the total monomer.

The acrylic polymer is obtained by polymerizing a single monomer or a mixture of two or more monomers. The polymerization can also be any method such as solution polymerization, emulsion polymerization, mass polymerization and suspension polymerization.

It is suitable for the weight average molecular weight of the acrylic polymer to be about 200,000 to 3,000,000, and preferably about 250,000 to 1,500,000. The weight average molecular weight of the polymer can be found by gel permeation chromatography (GPC).

The polymer constituting the adhesive may have a cross linked structure.

An adhesive such as this can be obtained by adding a cross linking agent to a polymer obtained from a monomer mixture containing a monomer (such as an acrylic monomer) having a carboxyl group, hydroxyl group, epoxy group, amino group, or other such functional group. With a sheet equipped with an adhesive layer containing a polymer that has a cross linked structure, the sheet is more self-supporting, so deformation of the sheet can be prevented, and the sheet can be kept flat. This means that the sheet can be affixed easily and accurately to the semiconductor wafer using an automatic affixing device or the like.

A radiation curing type adhesive as described below can be used for the adhesive layer, and introduced the cross linked structure by using a known cross-linking agent such as epoxy-based cross-linking agent, an aziridine-based cross-linking agent, an isocyanate-based cross-linking agent and a melamine-based cross-linking agent.

Examples of the epoxy compound include, for example, sorbitol tetraglycidyl ether, trimethylolpropane glycidyl ether, tetraglycidyl-1,3-bisaminomethylcyclohexane, tetraglycidyl-m-xylenediamine and triglycidyl-p-aminophenol.

Examples of the aziridine compound include, for example, 2,2-bishydroxymethylbutanol-tris[3-(1-aziridinyl)propionate] and 4,4-bis(ethyleneiminocarbonylamino)diphenylmethane.

Examples of the isocyanate compound include, for example, diphenyl methandiisosianate, tolylene diisocyanate, hexamethylene diisocyanate and polyisocyanate.

Examples of the melamine compound include, for example, hexamethoxymethylmelamine.

These cross-linking agents can be used alone or as mixture of two or more compounds. The amount is suitably adjusted to about 0.05 to 4 parts by weight per 100 parts by weight the base polymer to be cross-linked. To promote the reaction here, dibutyltin laurate or another such cross-linking catalysts that are normally used in adhesives may be used.

With the present invention, it is good to use a radiation curing type of adhesive for the adhesive layer. Using a radiation curing type of adhesive for the adhesive layer allows the layer to be easily peeled from the wafer because irradiation lowers the adhesion when the sheet is peeled away.

As a radiation curing adhesive, an acrylic polymer having carbon-carbon double bonds or the addition to an adhesive substance of an oligomer component that forms a low adhesion substance when cured by radiation (hereinafter referred to as a radiation curing oligomer) can be used. An acrylic polymer having carbon-carbon double bonds and an oligomer component may also be used together.

There is no particular limitation as long as it is possible to cure polymer for example, radiation of various wavelengths, such as X rays, electron beam, ultraviolet rays, visible light rays, or infrared rays. Of these, it is preferable to use ultraviolet rays because of easy handling.

Any method known in this field can be used to introduce a carbon-carbon double bond into a side chain in the acrylic polymer molecule. For ease of molecular design and the like, examples of the method include a method in which a monomer having a functional group is copolymerized to an acrylic polymer, after which this polymer and a compound which has a carbon-carbon double bond and a functional group having reactivity to the functional group of the monomer are reacted (condensation, addition reaction, etc.) while radiation curing property of this carbon-carbon double bond is preserved.

Examples of the combination of the function groups include a combination of a carboxyl group and an epoxy group, a carboxyl group and an aziridine group, and a hydroxyl group and an isocyanate group. Of these, the combination of a hydroxyl group and an epoxy group is preferable from the view point of easy reaction trace.

In combinations of these functional groups, the functional groups may be either on the acrylic copolymer side or on the side of the compound having the functional group and polymerizable carbon-carbon double bond. It is preferably for the acrylic copolymer to have a hydroxyl group and for the compound having functional groups and polymerizable carbon-carbon double bonds to have an isocyanate group.

Examples of the compounds having a functional group and a carbon-carbon double bond include methacryloyl isocyanate, 2-methacryloyloxyethyl isocyanate, m-isopropenyl-α,α-dimethylbenzyl isocyanate, acryloyl isocyanate, 2-acryloyloxyethyl isocyanate and 1,1-bis(acryloyloxymethyl)ethyl isocyanate.

Examples of the acrylic copolymer include a copolymer which is copolymerized ether compounds such as the above hydroxyl-containing monomers, 2-hydroxyethylvinylether, 4-hydroxybutylvinylether and diethyleneglycol monovinylether.

The acrylic copolymers having carbon-carbon double bonds can be used alone or as mixture of two or more monomers.

Examples the radiation curing oligomer which is contained in a radiation curing type adhesive include urethane-based, polyether-based, polyester-based, polycarbonate-based, polybtadiene-based and other various oligomers. In particular, examples such oligomer include trimethylolpropane tri(meth)acrylate, pentaerythritol tri(meth)acrylate, dipentaerythritol hexa(meth)acrylate, tetraethyleneglycoldi(meth)acrylate, 1,6-hexanediol(meth)acrylate, neopenthylglycoldi(meth)acrylate, an esterified compound with (meta)acrylic acid and polyol, an esterified acrylate oligomer, 2-propenyl-3-butenylcyanurate, isocyanurate and an isocyanurate compound. These oligomers can be used alone or as mixture of two or more oligomers. The oligomer is generally added in an amount of about 30 parts by weight or less, and preferably about 0 to 10 parts by weight per 100 parts by weight of the base polymer.

The radiation curing type adhesive generally contains a polymerization initiator.

Any polymerization initiator known in this field can be used.

Examples of a photopolymerization initiator include, for example,

an acetophenone photopolymerization initiator such as methoxy acetophenone, diethoxy-acetophenone (e.g., 2,2-diethoxy acetophenone), 4-phenoxydichloro acetophenone, 4-t-butyldichloro acetophenone, 2-hydroxy-2-methyl-1-phenylpropane-1-on, 1-(4-isopropylphenyl)-2-hydroxy-2-methylpropane-1-on, 1-(4-dodecylphenyl)-2-hydroxy-2-methylpropane-1-on, 4-(2-hydroxyethoxy)phenyl (2-hydroxy-2-propyl)ketone, 1-hydroxycyclohexyl phenyl ketone, 2-methyl-1-[4-(methylthio)phenyl]-2-morpholinopropane-1 and 2,2-dimethoxy-2-phenyl acetophenone;

an α-ketol photopolymerization initiator such as 4-(2-hydroxyethoxy)phenyl(2-hydroxy-2-propyl)ketone, α-hydroxy-α, α′-dimethylacetophenone, 2-methyl-2-hydroxypropiophenon and 1-hydroxycyclohexylphenylketone;

a ketal photopolymerization initiator such as benzyldimethyl ketal;

a benzoine photopolymerization initiator such as benzoine, benzoine methyl ether, benzoine ethyl ether, benzoine isopropyl ether and benzoine isobutyl ether;

a benzophenone photopolymerization initiator such as benzophenone, benzoylbenzoate, benzoylbenzoate methyl, 4-phenyl benzophenone, hydroxy benzophenone, 4-benzoyl-4′-methyldiphenylsulfide and 3,3′-dimethyl-4-methoxybenzophenone;

a thioxanthone photopolymerization initiator such as thioxanthone, 2-chlorothioxanthone, 2-methylthioxanthone, 2,4-dimethylthioxanthone, isopropylthioxanthone, 2,4-dichlorothioxanthone, 2,4-diethylthioxanthone and 2,4-diisopropylthioxanthone;

an aromatic sulfonyl chloride photopolymerization initiator such as 2-naphthalene sulfonyl chloride;

a light-active oxime photopolymerization initiator such as 1-phenon-1,1-propanedione-2-(o-ethoxycarbonyl)oxime;

a specialized photopolymerization initiator such as α-acyloxim ester, methylphenyl glyoxylate, benzyl, camphor quinine, dibenzosuberone, 2-ethyl anthraquinone, 4′,4″-diethylisophthalophenone, ketone halide, acyl phosphinoxide and acyl phosphonate.

It is suitable for the polymerization initiator to be added in an amount of about 1 to 10 parts by weight per 100 parts by weight of the radiation curing type polymer (or oligomer).

The adhesive layer may also contain a component that foams or expands under heating. Examples of thermal foaming or expanding components include thermal expanding microspheres in which a substance that readily gasifies under heating, such as isobutane or propane, is encased in an elastic shell (a specific example is Microspheres® made by Matsumoto Yushi-Seiyaku). If the adhesive layer contains such a thermal foaming or thermal expanding component, then the adhesive layer can be expanded by heating after wafer grinding, which markedly reduces the contact surface area between the adhesive layer and the wafer, so the sheet can be more easily peeled from the wafer.

In addition to the above components, the adhesive may optionally comprise any known additive in the field such as a flexibilizer, antioxidant, curative agent, filler, ultraviolet absorbing agent, light stabilizer, polymerization initiator, tackifier, pigment and the like. These additives can be used alone or as mixture of two or more additives.

Regardless of the material, the adhesive layer thickness is preferably 1 to 50 μm, and more preferably about 5 to 30 μm.

Keeping the thickness within this range, that is, making the layer as thin as possible, allows the layer to conform suitably to the irregularities on the surface of the semiconductor wafer. This effectively prevents cracking, dimpling, and the like from occurring during the grinding of the semiconductor wafer, particularly when the grinding thickness is low as in recent years.

The shear stress of the adhesive layer is preferably from 0.5 to 10 MPa, and more preferably 0.7 MPa or more, further preferably 8.5 MPa or less, and more preferably 7.1 MPa or less.

When the adhesive layer of the adhesive sheet is a radiation curing type, this shear stress refers to the value prior to radiation curing, that is, at the point when the adhesive sheet has been affixed to the semiconductor wafer.

The shear stress can be measured using a Tension RTC-1150A made by Orientec, for example. The measurement conditions in this case can be adjusted as needed, but may include a test piece size of 50×10 mm, a chuck spacing of 10 mm, and a pulling rate of 50 mm/minute, for example.

Adjusting the shear stress to within this range combines with the above-mentioned adhesive layer thickness to afford better conformation to the irregularities on the semiconductor wafer, and also to allow the adhesive layer to suitably absorb stress during peeling, so that the original shape of the adhesive layer is maintained and sticky residue of the adhesive is kept to a minimum.

Furthermore, if the adhesive layer thickness and shear stress are both adjusted to within these ranges, and a good balance is struck between thickness and shear stress, this will suppress penetration of the adhesive layer between the irregularities on the circuit formation surfaces that have become larger in recent years in semiconductor wafers, that is, it will suppress excessive embedding of the convex components by the adhesive layer, so that the semiconductor wafer can be bonded and supported favorably between the irregularities. Also, stress exerted on the semiconductor wafer during grinding can be favorably compensated for, and wafer cracking and dimpling can be kept to an absolute minimum. Furthermore, the proper self-support, hardness, and other such properties of the adhesive layer can be ensured, so this is particularly effective at preventing sticky residue of the adhesive layer on the semiconductor wafer, the side with the irregularities, etc.

Of these, it is suitable that (i) the adhesive layer thickness is 1 to 50 μm and shear stress is 0.5 to 10 MPa, and more preferable that (ii) the adhesive layer thickness is 5 to 30 μm and shear stress is 0.5 to 10 MPa. Further, it is more preferable that

(iii) the adhesive layer thickness is 1 to 50 μM and shear stress is 0.7 to 10 MPa,

(iv) the adhesive layer thickness is 1 to 50 μm and shear stress is 0.7 to 8.5 MPa,

(v) the adhesive layer thickness is 1 to 50 μm and shear stress is 0.7 to 7.1 MPa,

(vi) the adhesive layer thickness is 5 to 30 μm and shear stress is 0.7 to 10 MPa,

(vii) the adhesive layer thickness is 5 to 30 μm and shear stress is 0.7 to 8.5 MPa,

(viii) the adhesive layer thickness is 5 to 30 μm and shear stress is 0.7 to 7.1 MPa.

The adhesive layer also preferably has an adhesive strength of 1.0 to 20 N/20 mm in the affixing step. The adhesive strength referred to here is the value measured by peeling the layer from the lead frame at a measurement temperature of 25° C., a peeling angle of 180°, and a peeling rate of 300 mm/minute (as set forth in JIS Z 0237). This measurement can be performed with a commercially available measurement apparatus (such as an Autograph AG-X made by Shimadzu Seisakusho).

If the adhesive layer of the adhesive sheet is a radiation curing type, then this adhesive strength refers to the value prior to radiation curing. During peeling, the adhesive strength is usually about 0.1 N/20 mm or less.

It is suitable for the intermediate layer of the adhesive sheet of the present invention to have a thickness of 10 to 500 μm, preferably 10 to 300 mm, and more preferably 10 to 150 μm. Within this range, the layer will conform well to the irregularities on the wafer pattern surface, and cracking, dimpling, and the like can be prevented during grinding of the wafer. This also makes the sheet easier to affix, improves work efficiency, and suitably absorbs the bending stress of the adhesive sheet during peeling of the adhesive sheet.

The intermediate layer may consist of a single layer, but it may also have a multilayer structure composed of a plurality of layers of the same or different type.

The intermediate layer has an elastic modulus of 0.01 to 10 MPa, and preferably 0.06 MPa or more, further preferably 5 MPa or less, more preferably 3 MPa or less and still more preferably 2.1 MPa or less. If the modulus of elasticity is within this range, the adhesive will have suitable hardness, so the intermediate layer will retain its shape stability, and excessive deformation of the adhesive sheet can be prevented. Also, conformity to the irregularities on the semiconductor wafer surface can be kept to a favorable level, and water penetration, cracking, dimpling, and the like can be effectively prevented during wafer grinding.

The elastic modulus referred to here is a parameter indicating the “elastic characteristics” at 25° C. in dynamic viscoelasticity measurement, and is the elastic modulus G′ at 25° C. when the intermediate layer is measured with a Rheometric Ares dynamic viscoelasticity measurement apparatus (made by Rheometric) at a frequency of 1 Hz, a plate diameter of 7.9 mm, a distortion of 1% (25° C.), and a sample thickness of 3 mm.

If a radiation curing type of adhesive is used for the intermediate layer, then the term elastic modulus refers to that of the intermediate layer prior to radiation curing, that is, at the point when it is affixed.

Of these, it is suitable that (i) the intermediate layer thickness is 10 to 500 μm and elastic modulus is 0.01 to 10 MPa, and more preferable that (ii) the intermediate layer thickness is 10 to 500 μm and elastic modulus is 0.06 to 5 MPa (and preferably elastic modulus of 0.01 to 3 MPa). Further, it is more preferable that

(iii) the intermediate layer thickness is 10 to 500 μm and elastic modulus is 0.06 to 3 MPa,

(iv) the intermediate layer thickness is 10 to 500 μm and elastic modulus is 0.06 to 2.1 MPa,

(v) the intermediate layer thickness is 10 to 300 μm and elastic modulus is 0.01 to 10 MPa,

(vi) the intermediate layer thickness is 10 to 300 μm and elastic modulus is 0.01 to 5 MPa,

(vii) the intermediate layer thickness is 10 to 300 μm and elastic modulus is 0.06 to 3 MPa,

(viii) the intermediate layer thickness is 10 to 300 μm and elastic modulus is 0.06 to 2.1 MPa,

(ix) the intermediate layer thickness is 10 to 150 μm and elastic modulus is 0.01 to 10 MPa,

(x) the intermediate layer thickness is 10 to 150 μm and elastic modulus is 0.06 to 5 MPa,

(xi) the intermediate layer thickness is 10 to 150 μm and elastic modulus is 0.06 to 3 MPa,

(xii) the intermediate layer thickness is 10 to 150 μm and elastic modulus is 0.06 to 2.1 MPa,

As long as it has the above-mentioned elastic modulus and thickness, there are no particular restrictions on the material of the intermediate layer, but it can be formed by suitably selecting and adjusting the resin material, such as from one of those listed as examples of the above adhesives.

It is particularly preferable if the intermediate layer has adhesion (anchoring) with the adhesive layer. For example, an acrylic polymer is favorable in terms of ease of adjusting the elastic modulus, interaction with the adhesive layer, and the like. This intermediate layer may be either a radiation curing type of adhesive or a non-radiation curing type.

Examples of a main monomer constituting the acrylic polymer include an alkyl ester of (meth)acrylic acid described above such as butyl (meth)acrylate, 2-ethylhexyl (meth)acrylate, isononyl(meth)acrylate, isooctyl (meth)acrylate, lauryl (meth)acrylate, i.e., a C₄ to C₁₂ alkyl (meth)acrylate. These monomers can be used alone or as mixture of two or more monomers.

The acrylic polymer may be a copolymer that is copolymerized with the above monomer and another copolymerizable monomer, for the purpose of modifying the elastic modulus or to meet other property required.

The amount of another monomer is preferable about less than 30 wt % with respect to the total monomer.

Examples of such another monomer include;

a carboxyl-containing monomer such as (meth)acrylic acid, itaconic acid, maleic acid, crotonic acid, fumaric acid, maleic anhydride and itaconic anhydride;

a functional monomer such as hydroxyalkyl (meth)acrylate, glycerin di(meth)acrylate, glycidyl (meth)acrylate, methyl glycidyl (meth)acrylate, aminoethyl (meth)acrylate, 2-(meth)acryloyloxy ethyl isocyanate;

a multifunctional monomer such as triethylene glycol di(meth)acrylate, ethylene glycol di(meth)acrylate, trimethylolpropane tri(meth)acrylate;

vinyl acetate; styrene, (meth)acrylonitrile, N-vinylpyrrolidone, (meth)acryloyl morpholine, cyclohexyl maleimide, isopropyl maleimide, and (meth) acrylamide.

The acrylic-based polymer constituting the intermediate layer can be also produced as the same method described above.

There are no particular restrictions on the weight average molecular weight of the polymer used in the intermediate layer as long as the characteristics can be maintained in the above ranges, but between 10,000 and 2,000,000 is preferable.

Just as discussed above, a cross-linked structure may be introduced into the polymer used in the intermediate layer. Furthermore, just as discussed above, various additives may also be contained.

The base film of the present adhesive sheet may be formed by a thermoplastic and thermosetting resin, for example, polyester-based resin such as polyester (PET); polyolefin-based resin such as polyethylene (PE), polypropylene (PP); polyimide (PI); polyether ether ketone (PEEK); polyvinyl chloride-based resin such as polyvinyl chloride (PVC); vinylidene chloride-based resin; polyamide-based resin; polyurethane; polystylene-based resin; acrylic-based resin; fluorine-based resin; cellulose-based resin; polycarbonate-based resin; methal film; paper and the like. The base film may be a single layer or may be a laminated structure of same materials or different materials.

The semiconductor wafer supporting and protecting sheet of the present invention may be rolled-up as a tape. In this case, a release film layer may be laminated on top to protect the adhesive layer. The release film layer can be formed from a plastic film such as PET and PP, paper, non-polar material such as PE and PP, or the like that have undergone a conventional silicone treatment or fluorine treatment.

The thickness of the base film may be adapted generally of about 5 to 400 μm, preferably of about 10 to 300 μm, and still more preferably of about 30 to 200 μm.

When the adhesive layer discussed below is a radiation curing type of adhesive, the base film is preferably one that can transmit at least a specific amount of radiation (such as a resin that is transparent) so that the radiation can be applied through the base film.

The base film may be formed by a known method for film formation, for example, a wet-casting method, an inflation method, a T-die extrusion method or the like. The base film may be either non-stretched, or subjected to a uniaxial or biaxial stretching process.

From another standpoint, the adhesive sheet of the present invention for supporting and protecting a semiconductor wafer may be an adhesive sheet composed of a base film and an adhesive layer.

In this case, the adhesive layer may be formed from a single layer, but will preferably have a laminated structure of two or more layers.

In the case of a single layer, the above-mentioned adhesive layer may be used as it is, but it is preferable to suitably adjust the film thickness, shear stress, elastic modulus, and the like.

The thickness may be adapted of about 10 to 550 μm, preferably of about 15 to 300 μm, and still more preferably of about 15 to 150 μm.

The shear stress may be preferably of about 0.5 to 10 MPa, more preferably of about 0.7 MPa or more, still more preferably 8.5 MPa or less, and further preferably 7.1 MPa ore less.

The elastic modulus may be adapted of about 0.01 to 10 MPa, preferably of about 0.06 MPa or more, 5 MPa or less, 3 MPa or less, and still more preferably of about 2.1 MPa or less.

In the case of a laminated structure, the film thickness and parameters of the laminated structure can be suitably selected and adjusted according to the combination of film thickness and parameters between the above-mentioned adhesive layer and intermediate layer.

There are no particular restrictions on the configuration of the adhesive sheet of the present invention, which may be in the form of a sheet, a tape, or the like. A roll-up form is also possible, in which case, if no release film layer is used, and instead a release treated layer is provided to the opposite side of the base film (that is, the side in contact with the adhesive layer when the sheet has been rolled-up), or a parting layer (separator) is laminated, this will facilitate rewinding.

The release treated layer can be formed using a release agent that is known in this field. Examples include layers that have undergone a silicone treatment, fluorine treatment, long-chain alkyl group-containing polymer treatment, and the like.

The adhesive sheet of the present invention can be formed by coating a base film layer with an adhesive composition to form an adhesive layer. To apply the adhesive composition, roll coating, screen coating, gravure coating, or another such coating method may be utilized, and the coating may be formed directly on the base film, or may be transferred to the base film after first being formed on release paper whose surface has undergone a release treatment, etc.

The semiconductor supporting and protecting sheet of the present invention can be used to advantage, for example, on semiconductor wafer surfaces having irregularities that originate in a circuit pattern, etc. The irregularity may have a height of about 15 μm or more (preferably 20 to 200 μm), a width of about 50 to 200 μm (or diameter), and a pitch of about 100 to 300 μm.

The adhesive sheet is superposed with the semiconductor wafer surface (circuit pattern formation surface) so that the side with the adhesive layer will be on the wafer side, and is affected under pressure.

For example, (i) the wafer is placed on a table, the adhesive sheet of the present invention is placed over this so that the adhesive layer is on the wafer side, and the sheet is affixed by being pressed with a compression roll or other such pressing means.

Also, (ii) the wafer and the adhesive sheet are put together as mentioned above in a pressurizable vessel (such as an autoclave), and pressure is applied inside the vessel to affix the sheet to the wafer.

Here, the sheet may be affixed while being pressed with a pressing means.

Further, (iii) the sheet can be affixed in the same manner as described above within a vacuum chamber.

In affixing the sheet by these methods, heating may be performed at about 30 to 150° C.

With the adhesive sheet affixed, the back of the semiconductor wafer is ground, for example. In this case, it is good for the amount of grinding suitably adjusted. The purpose of this is to prevent excessive pressure by the adhesive sheet onto the semiconductor wafer, excessive embedding of the irregularities on the semiconductor wafer surface by the adhesive layer, and the like, and thereby avoid breakage of the adhesive embedded between the irregularities, sticky residue on the semiconductor wafer side, and the like.

The affixed adhesive sheet is peeled off, either manually or by machine, after the grinding of the semiconductor wafer. When a radiation curing type of adhesive is used, the sheet is irradiated with a suitable radiation prior to peeling to lower the adhesive strength of the adhesive layer and allow the sheet to be peeled off more easily.

When the adhesive sheet of the present invention is used in grinding, the bump height (H) of the semiconductor wafer versus the thickness (T) of the adhesive layer is adjusted, for example, to about T/H=0.2 to 2.0.

The adhesive sheet for dicing a semiconductor wafer of the present invention will now be described in detail on the basis of examples. All parts and percentages in the examples and comparative examples are by weight unless otherwise indicated.

Firstly, the following pressure sensitive adhesives and ultraviolet curing type adhesives were prepared as materials of an intermediate layer and/or an adhesive layer.

### Adhesive for Intermediate Layer 1

50 parts butyl acrylate, 7 parts acrylic acid and 50 parts of ethyl acrylate were copolymerized by a solution polymerization in toluene to obtain a polymer.

To 100 parts this obtained polymer was added 0.05 parts epoxy-based cross-linking agent (trade name “tetrad C,” made by Mitsubishi gas chemical company, Inc.), 10 parts ultraviolet curing oligomer (trade name “UV-1700B,” made by Nippon Synthetic Chemical Industry) and 2 parts acetophenone photopolymerization initiator (trade name “Irgacure 651,” made by Ciba Specialty Chemicals) and mixed to prepare a adhesive solution.

This solution is used to coat a 38 μm-thick silicone release-treated polyester film and is dried for 2 minutes at 120° C. to form an intermediate layer. This layer had an initial elastic modulus of 0.06 MPa.

### Adhesive for Intermediate Layer 2

95 parts butyl acrylate and 5 parts acrylic acid were copolymerized by a solution polymerization in toluene to obtain a polymer.

To 100 parts this obtained polymer was added 4 parts melamine-based cross-linking agent (trade name “super beckmin SJ-820-60N) and 3.00 parts isocyanate-based cross-linking agent (trade name “Coronate L,” made by Nippon Polyurethane Industry) and mixed to prepare a adhesive solution.

This solution is used to coat a 38 μm-thick silicone release-treated polyester film and is dried for 2 minutes at 120° C. to form an intermediate layer. This layer had an initial elastic modulus of 2.1 MPa.

### Adhesive for Intermediate Layer 3

50.0 parts t-butyl acrylate, 30.0 parts acrylic acid and 20 parts of butyl acrylate as acrylic monomer, 0.1 parts 1-[4-(2-hydroxyethoxy)-phenyl]-2-hydroxy-2-methyl-1-propane-1-on (trade name “Irgacure 2959,” made by Ciba Specialty Chemicals) as a photopolymerization initiator, 73.4 parts polyoxy tetramethylene glycol (650 of molecular weight, Mitsubishi Chemical Ltd.) as a polyol and 0.05 parts dibutyl tinlaurate as an urethane reacting catalyst were introduced into a reaction vessel. 26.6 parts xylylene diisocyanate was dropped into this mixture while stirring to reacted for 2 hours at 65° C., thereby giving a mixture of an urethane polymer-acrylic-based monomer mixture.

Thus obtained mixture of the urethane polymer-acrylic-based monomer was used to coat a 75 μm-thick polyethylene terephthalate film (a base film PET #75) and cured by irradiating ultraviolet light (illumination intensity of 163 mW/cm², light intensity of 2100 mJ/cm²) by using high-pressure mercury lamp, thereby giving an intermediate layer. This layer had an initial elastic modulus of 15 MPa.

### Adhesive for Adhesive Layer 1

80 parts butyl acrylate, 5 parts acrylic acid and 20 parts cyanomethyl acrylate were copolymerized to obtain an acrylic copolymer with a weight average molecular weight of 800,000 (solid content of 30%).

To 100 parts of this obtained polymer was added 30 parts dipentaerythritol hexaacrylate (made by Nippon Kayaku Ltd.), 1.00 parts isocyanate-based cross-linking agent (trade name “Coronate L,” made by Nippon Polyurethane Industry), 0.2 parts epoxy cross-linking agent (trade name “tetrad C,” made by Mitsubishi gas chemical company, Inc.) and 1 parts photopolymerization initiator (trade name “Irgacure 651,” made by Ciba Specialty Chemicals) to prepare a resin solution.

This solution was used to coat a 38 μm-thick silicone release-treated polyester film and was dried for 2 minutes at 140° C. to form an adhesive layer. This layer had a shear stress of 0.7 MPa.

### Adhesive for Adhesive Layer 2

80 parts butyl acrylate, 5 parts acrylic acid and 20 parts cyanomethyl acrylate were copolymerized to obtain an acrylic copolymer with a weight average molecular weight of 800,000 (solid content of 30%).

To 100 parts of this obtained polymer was added 20 parts dipentaerythritol hexaacrylate (made by Nippon Kayaku Ltd.), 3.00 parts isocyanate-based cross-linking agent (trade name “Coronate L,” made by Nippon Polyurethane Industry), 1.00 parts epoxy cross-linking agent (trade name “tetrad C,” made by Mitsubishi gas chemical company, Inc.) and 1 parts photopolymerization initiator (trade name “Irgacure 651,” made by Ciba Specialty Chemicals) to prepare a resin solution.

This solution is used to coat a 38 μm-thick silicone release-treated polyester film and was dried for 2 minutes at 140° C. to form an adhesive layer. This layer had a shear stress of 1.5 MPa.

### Adhesive for Adhesive Layer 3

40 parts methyl acrylate, 10 parts acrylic acid and 60 parts 2-ethylhexyl acrylate were copolymerized to obtain an acrylic copolymer with a weight average molecular weight of 700,000 (solid content of 35%).

To 100 parts of this obtained polymer was added 15 parts dipentaerythritol hexaacrylate (made by Nippon Kayaku Ltd.), 3.00 parts isocyanate-based cross-linking agent (trade name “Coronate L,” made by Nippon Polyurethane Industry), 4.00 parts epoxy cross-linking agent (trade name “tetrad C,” made by Mitsubishi gas chemical company, Inc.) and 1 parts photopolymerization initiator (trade name “Irgacure 651,” made by Ciba Specialty Chemicals) to prepare a resin solution.

This solution was used to coat a 38 μm-thick silicone release-treated polyester film and was dried for 2 minutes at 140° C. to form an adhesive layer. This layer had a shear stress of 7.1 MPa.

### Adhesive for Adhesive Layer 4

40 parts methyl acrylate, 10 parts acrylic acid and 60 parts 2-ethylhexyl acrylate were copolymerized to obtain an acrylic copolymer with a weight average molecular weight of 700,000 (solid content of 35%).

To 100 parts of this obtained polymer was added 50 parts UV-3000B and 50 parts UV-1700B (multifunctional acrylate-based oligomer, made by Nippon Synthesis Ltd.) as a multifunction acrylic oligomer, 1.00 parts isocyanate-based cross-linking agent (trade name “Coronate L,” made by Nippon Polyurethane Industry), 0.1 parts epoxy cross-linking agent (trade name “tetrad C,” made by Mitsubishi gas chemical company, Inc.) and 3 parts photopolymerization initiator (trade name “Irgacure 651,” made by Ciba Specialty Chemicals) to prepare a resin solution.

This solution was used to coat a 38 μm-thick silicone release-treated polyester film and was dried for 2 minutes at 140° C. to form an adhesive layer. This layer had a shear stress of 0.2 MPa.

### Adhesive for Adhesive Layer 5

40 parts methyl acrylate, 10 parts acrylic acid and 60 parts 2-ethylhexyl acrylate were copolymerized to obtain an acrylic copolymer with a weight average molecular weight of 700,000 (solid content of 35%).

To 100 parts of this obtained polymer was added 5 parts dipentaerythritol hexaacrylate (made by Nippon Kayaku Ltd.), 4.50 parts isocyanate-based cross-linking agent (trade name “Coronate L,” made by Nippon Polyurethane Industry), 7.50 parts epoxy cross-linking agent (trade name “tetrad C,” made by Mitsubishi gas chemical company, Inc.) and 1 parts photopolymerization initiator (trade name “Irgacure 651,” made by Ciba Specialty Chemicals) to prepare a resin solution.

This solution was used to coat a 38 μm-thick silicone release-treated polyester film and is dried for 2 minutes at 140° C. to form an adhesive layer. This layer had a shear stress of 12 MPa.

### Example 1

The intermediate layer 20 (60 μm-thick) and the adhesive layer 30 (5 μm-thick) were formed on the 115 μm-thick ethylene-vinyl acetate copolymer (EVA) film as the base film 10, as shown in FIG. 1.

### Examples 2 to 5 and Comparative Examples 1 to 3

115 μm-thick ethylene-vinyl acetate copolymer (EVA) film or 100 μm-thick polyethylene (PE) film was used as the base film.

The intermediate layer and the adhesive layer were formed respectively on the base film according to Example 1 so as to have a thickness as shown in Table 1.

The obtained adhesive sheet was affixed to a silicon wafer, the wafer was ground, and the adhesive sheet was peeled off, after which the following evaluations were performed. 25 adhesive sheets were prepared for and evaluated in each of the Examples and Comparative Examples. These results are given in Table 1.

### Affixing

The adhesive sheet was affixed so that the adhesive layer was disposed on the side of an 8-inch silicon wafer on which a dummy bump electrode had been formed. The silicon wafer had bump electrodes, each with a height of 50 μm and a diameter of 100 μm, formed in a matrix at a pitch P of 200 μm, and the wafer had a thickness of 725 μm (not including the bumps). The adhesive sheet was affixed with a DR-3000II made by Nitto Seiki. This corresponds to method (i) discussed above (in which the wafer is placed on a table, the adhesive sheet of the present invention is placed over this so that the adhesive layer is on the wafer side, and the sheet is affixed by being pressed with a compression roll or other such pressing means).

### Grinding

The wafer to which the adhesive sheet was affixed was ground down to a thickness of 100 μm with a DFG 8560 silicon wafer grinder made by Disco (i.e., finally the thickness of 625 μm.

### Peeling

The adhesive sheet was peeled off at normal temperature from the ground wafer using an HR-8500II made by Nitto Seiki. When the pressure sensitive adhesive was used for the adhesive, a release tape was affixed to the back of the adhesive sheet after grinding, and the adhesive sheet was peeled off along with this tape. When the UV adhesive was used for the adhesive, the adhesive sheet was irradiated with 400 mJ/cm² of ultraviolet rays after the wafer was ground, which cured the adhesive layer, and a release tape was similarly affixed and the adhesive sheet was peeled off along with this tape.

### Evaluation Categories

### Embedding

When the adhesive sheet was affixed as discussed above to a silicon wafer on which dummy bump electrodes had been formed, the embedding of the sheet was observed.

As shown in FIG. 2a, embedding was rated “o” when the adhesive layer 30 was only in contact with the top portions of the bump electrodes 60, and not in contact with the surface below the bump electrodes 60, and was in contact with the wafer surface between the bump electrodes 60, and in contact with the outer periphery of the wafer 50 where the bump electrodes 60 were not formed.

Meanwhile, as shown in FIG. 2b, embedding was rated “x” when there was even one place where the adhesive layer 30 was not in contact with the wafer surface between the bump electrodes 60 and the bump electrodes 60 were not embedded.

### Grindability

Wafer cracking occurs when bump irregularities are not absorbed by the adhesive sheet during grinding. If no wafer cracking occurred during grinding the rating was “o,” but if cracking occurred in even one of the 25 wafers the rating was “x”,

### Sticky Residue

After grinding, the adhesive sheet was peeled off and the outer periphery of the wafer was observed under an optical microscope (500×). The rating was “x” when residue of the adhesive was noted, and “o” when there was no sticky residue.

TABLE 1

| | Base Film/ | | Intermediate Layer | | | Adhesive layer | | |
|---|---|---|---|---|---|---|---|---|
| | Thickness | | Thickness | Type | Elastic Modulus | Thickness | Type | Shear Stress |
| Ex. | | | | | | | | |
| 1 | EVA/115 | μm | 60 μm | 1 | 0.06 MPa | 5 μm | 1 | 0.7 MPa |
| 2 | EVA/115 | μm | 80 μm | 1 | 0.06 MPa | 5 μm | 2 | 1.5 MPa |
| 3 | EVA/115 | μm | 150 μm | 1 | 0.06 MPa | 5 μm | 3 | 7.1 MPa |
| 4 | EVA/115 | μm | 10 μm | 2 | 2.10 MPa | 30 μm | 1 | 0.7 MPa |
| 5 | PE/100 | μm | 60 μm | 1 | 0.06 MPa | 5 μm | 1 | 0.7 MPa |

| Comp. Ex. | | | | | | | |
|---|---|---|---|---|---|---|---|
| 1 | EVA/115 μm | 60 μm | 1 | 0.06 MPa | 5 μm | 4 | 0.2 MPa |
| 2 | EVA/115 μm | 150 μm | 1 | 0.06 MPa | 5 μm | 5 | 12 MPa |
| 3 | EVA/115 μm | 10 μm | 3 | 15 MPa | 30 μm | 1 | 0.7 MPa |

| | Embedding | Grindability | Sticky Residue |
|---|---|---|---|
| Ex. | | | |
| 1 | ∘ | ∘ | ∘ |
| 2 | ∘ | ∘ | ∘ |
| 3 | ∘ | ∘ | ∘ |
| 4 | ∘ | ∘ | ∘ |
| 5 | ∘ | ∘ | ∘ |
| Comp. Ex. | | | |
| 1 | ∘ | ∘ | x |
| 2 | x | ∘ | ∘ |
| 3 | x | x | ∘ |

The adhesive sheet of the present invention is useful in the broader application such as an adhesive sheet for affixing a wafer and for protecting a wafer, and the like in various steps of working the semiconductor wafers, that needs re-peelable.

It is to be understood that although the present invention has been described in relation to preferred embodiments thereof, various other embodiments and variants may occur to those skilled in the art as within the scope and spirit of the invention, and such other embodiments and variants are intended to be covered by the following claims.

This application claims priority to Japanese Patent Application No. JP2009-184083 filed on 7 Aug. 2009. The entire disclosure of Japanese Patent Application No. JP2009-184083 is hereby incorporated herein by reference.

What is claimed is:

1. An adhesive sheet for supporting and protecting a semiconductor wafer comprising an intermediate layer and an adhesive layer formed on a one side of a base film in this order,
the adhesive layer being made of a radiation curing type adhesive, and having a thickness of 1 to 50 μm and a shear stress of 0.5 to 10 MPa,
the intermediate layer having a thickness of 10 to 500 μm and an elastic modulus of 0.01 to 3 MPa.

2. The adhesive sheet for supporting and protecting a semiconductor wafer according to claim 1, wherein the base film has an elastic modulus of 0.01 to 10 MPa.

3. The adhesive sheet for supporting and protecting a semiconductor wafer according to claim 1, wherein the adhesive layer has an adhesive strength of 1.0 to 20 N/20 mm in the affixing step.

4. The adhesive sheet for supporting and protecting a semiconductor wafer according to claim 1, wherein the adhesive layer contains an acrylic polymer as a constituting material.

5. The adhesive sheet for supporting and protecting a semiconductor wafer according to claim 1, wherein the adhesive layer contains a radiation curing type acrylic polymer having carbon-carbon double bonds.

6. The adhesive sheet for supporting and protecting a semiconductor wafer according to claim 1, wherein the adhesive layer is a radiation curing type adhesive layer containing a radiation curing type oligomer.

7. A method for grinding the back of a semiconductor wafer comprising a step of grinding the back of the semiconductor wafer at a state in which an adhesive sheet for supporting and protecting the semiconductor wafer according to claim 1 is affixed to the semiconductor wafer surface having a circuit pattern,
the circuit pattern having irregularities with 15 μm or more of height from the surface of the semiconductor surface.
